(19) United States
(12) Patent Application Publication
(10) Pub. No.: US 2013/0158944 A1
(43) Pub. Date: Jun. 20, 2013

(54) DEVICE FOR DETECTING MOTIONS AND METHOD FOR DETECTING MOTIONS

(71) Applicants: Byoung Won HWANG, Gyeonggi-do (KR); Kyung Rin KIM, Gyeonggi-do (KR); Chang Hyun KIM, Gyeonggi-do (KR)

(72) Inventors: Byoung Won HWANG, Gyeonggi-do (KR); Kyung Rin KIM, Gyeonggi-do (KR); Chang Hyun KIM, Gyeonggi-do (KR)

(73) Assignee: SAMSUNG ELECTRO-MECHANICS, Suwon (KR)

(21) Appl. No.: 13/486,689

(22) Filed: Jun. 1, 2012

(30) Foreign Application Priority Data
Dec. 15, 2011 (KR) 10-2011-0135595

(51) Int. Cl. G01B 7/14; G06F 15/00

(52) U.S. Cl. 702/150

(57) ABSTRACT

The present invention relates to a device for detecting motions and a method for detecting motions and includes a change rate calculation unit for calculating a change rate of signals outputted from the sensor, a decision range determination unit for determining the decision range in proportion to the change rate calculated in the change rate calculation unit, a motion decision unit for deciding the existence and inexistence of the motions from the signals outputted in the sensor based on the decision ranged determined in the decision range determination unit and an output unit for outputting the decision result of the motion decision unit.

### CROSS-REFERENCE TO RELATED APPLICATIONS

This application claims the benefit of Korean Patent Application No. 10-2011-0135595 filed with the Korea Intellectual Property Office on Dec. 15, 2011, the disclosure of which is incorporated herein by reference.

### BACKGROUND OF THE INVENTION

1. Field of the Invention

The present invention relates to a device for detecting motions and a method for detecting motions.

2. Description of the Related Art

Various sensors have been developed to output analog signals and/or digital signals by electrically or magnetically sensing the motions of human or objects.

Such sensors apply various methods and principles such as an acceleration sensor, an angular velocity sensor, a gyro sensor, a terrestrial magnetism sensor and an optical sensor.

At this time, since the acceleration sensor, the angular velocity sensor and the gyro sensor or the like is a sensor to measure an inertial physical force, they can be called as an inertial sensor; and, recently, a technology to be utilized for various applications by measuring the acceleration sensor and the angular velocity sensor at the same time has been continuously developed.

The output values obtained from the sensors may be outputted by being converted into an analog or a digital value and such output values may be used by being reflected on various application.

On the other hands, a conventional motion detecting method decides a period where a signal outputted in a sensor is larger than a predetermined threshold value by comparing the signal outputted by sensing motions by an inertial sensor as the motions exist to output the result and decides a period where a signal outputted in the sensor is smaller than the threshold value as the motions do not exist to output the result.

However, even when the motions are rapidly generated during a short time, the inertial sensor does not reflect a stop state on the output signal directly and output the signals reduced with being vibrated. Besides, the signals outputted in the inertial sensor even in various cases have ripples, in case when the motions can be detected by applying the fixed threshold value as a predetermined value, since the motion existence signal and the motion inexistence signal are very frequently outputted, the amount of data process of various devices including the inertial sensor or a host device connected thereto may be unnecessarily increased; and, in this result, the problem of overload can be generated.

In order to overcome such problem, there is proposed a method to give a predetermined tolerance range for a range larger than the threshold value or a range smaller than the threshold value.

That is, in case when the sensor output signals are changed between an upper value obtained by adding a tolerance range with reference to a threshold value and a lower value obtained by subtracting the tolerance range from the threshold value, it is decided as the motions are continuously monitored to output the result.

FIG. 1 is an exemplary view schematically showing a conventional device for detecting motions, FIG. 2A is a view explaining problems in case when a tolerance range is very narrow and FIG. 2B is a view explaining problems in case when a tolerance range is very wide.

A conventional device for detecting motions decides the motions with reference to a fixed threshold value or decides the motions by applying a predetermined tolerance range Δh.

But, as shown in FIG. 2A, in case when the tolerance range Δh is relatively narrow, there is a problem that the motion detection results are very frequently changed between H and L for the outputted signals by detecting the rapid motions.

And also, as shown in FIG. 2B, in case when the tolerance range Δh is relatively wide, there is a problem that the result is outputted as the motions do not exist even when the motions generated smoothly exceed the threshold value.

### RELATED ART DOCUMENT

### Patent Document

Patent Document 1: US Pat. Publication US2010/0256947

### SUMMARY OF THE INVENTION

The present invention has been invented in order to overcome the above-described problems and it is, therefore, an object of the present invention to provide a device for detecting motions and a method for detecting motions that are capable of sensing the motions by applying a decision range to be controlled according to the change rate of signals outputted in a sensor.

In accordance with one aspect of the present invention to achieve the object, there is provided a device for detecting motions in which existence and inexistence of the motions are determined by comparing signals outputted in a sensor to detect the motions with a predetermined determination range, including: a change rate calculation unit for calculating a change rate of signals outputted from the sensor; a decision range determination unit for determining the decision range in proportion to the change rate calculated in the change rate calculation unit; a motion decision unit for deciding the existence and inexistence of the motions from the signals outputted in the sensor based on the decision ranged determined in the decision range determination unit; and an output unit for outputting the decision result of the motion decision unit.

At this time, the decision range is ranged between an upper value obtained by adding a tolerance range with reference to a threshold value and a lower value obtained by subtracting the tolerance range with reference to the threshold value.

And also, the decision range determination unit determines the decision range by determining the tolerance range in proportion to the change rate calculated in the change rate calculation unit.

And also, the change rate calculation unit includes: a difference value calculation unit for calculating a difference value Diff of signals outputted from the sensor; and a representative value selection unit for selecting a maximum value or an average value of the difference value calculated in the difference value calculation unit.

And also, the change rate calculation unit includes: a difference value calculation unit for calculating a difference value Diff of signals outputted from the sensor; and a cumulative average calculation unit for calculating a cumulative average value of the difference value calculated in the difference value calculation unit.

And also, the difference value calculation unit calculates Diffₙ₊₁ as the n+1^{th} difference value according to a following equation 1, wherein the n is zero or a positive integer,

Diffₙ₊₁=dₙ₊₁−dₙ Equation 1.

And also, the cumulative average calculation unit calculates the difference value calculated in the difference value calculation unit according to a following equation 2, wherein the N is zero or a predetermined positive integer,

$$( {\sum }_{n = 0}^{N - 1} {Diff}_{n + 1} ) / N . \qquad Equation 2$$

And also, the change rate calculation unit includes: a slope calculation unit for calculating slopes of signals outputted from the sensor; and a representative value derivation unit for deriving a maximum value or an average value of the slopes calculated in the slope calculation unit.

And also, the slope calculation unit calculates L(t) as a slope at a specific time 5 according to a following equation 3,

$$L ( t ) = \frac{d}{d t} S ( t ) . \qquad Equation 3$$

In accordance with another aspect of the present invention to achieve the object, there is provided a method for detecting motions, in which existence and inexistence of the motions are determined by comparing signals outputted in a sensor to detect the motions with a predetermined determination range, including: (A) outputting signals according to motions by detecting the motions; (B) calculating change rates of the signals outputted in outputting signals; (C) determining a decision range in proportion to the change rate calculated in the calculating change rates; (D) determining existence and inexistence of the motions from the signals outputted from the sensor based on the decision range determined in determining the decision range; and (E) outputting the determined result of the determining existence and inexistence of the motions from the signals.

At this time, the decision range is ranged between an upper value obtained by adding a tolerance range with reference to a threshold value and a lower value obtained by subtracting the tolerance range with reference to the threshold value.

And also, determining the decision range determines the decision range by determining the tolerance range in proportion to the change rate calculated in the calculating change rates of the signals.

And also, calculating change rates of the signals includes: calculating a difference value Diff of signals outputted in the outputting signals according to motions; and calculating a cumulative average value of the calculated difference values.

And also, calculating the difference value Diff of signals calculates Diffn+1 as the n+1th difference value according to a following equation 1, wherein the n is zero or a positive integer,

Diffₙ₊₁=dₙ₊₁−dₙ Equation 1.

And also, calculating the cumulative average value of the calculated difference values calculates the difference value calculated in the difference value calculation unit according to a following equation 2, wherein the N is zero or a predetermined positive integer,

$$( {\sum }_{n = 0}^{N - 1} {Diff}_{n + 1} ) / N . \qquad Equation 2$$

And also, calculating change rates of the signals includes: calculating slopes of signals outputted from outputting signals according to motions; and deriving a maximum value or an average value of the calculated slopes.

At this time, calculating slopes of signals calculates L(t) as a slope at a specific time 5 according to a following equation 3,

$$L ( t ) = \frac{d}{d t} S ( t ) . \qquad Equation 3$$

In accordance with another aspect of the present invention to achieve the object, there is provided a method for detecting motions in which existence and inexistence of the motions are determined by comparing signals outputted in a sensor to detect the motions with a predetermined determination range, including: (A) outputting signals according to motions by detecting the motions; (B) calculating change rates of the signals outputted in outputting signals; (C) determining a decision range ranging from an upper value obtained by adding a tolerance range with reference to a threshold value to a lower value obtained by subtracting the tolerance range with reference to the threshold value in proportion to the change rate calculated in the calculating change rates; (D) determining existence and inexistence of the motions from the signals, wherein, if the signal outputted in outputting signals is higher than the upper value determined in determining the decision range, it is determined that the motion exists, whereas, if the signal outputted in outputting signals is lower than the lower value determined in determining the decision range, it is determined that the motion does not exist; and (E) outputting the determined result of the determining existence and inexistence of the motions from the signals.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exemplary view schematically showing a conventional device for detecting motions;

FIG. 2A is a view explaining problems in case when a tolerance range is very narrow;

FIG. 2B is a view explaining problems in case when a tolerance range is very wide;

FIG. 3 is an exemplary view schematically showing a device for detecting motions in accordance with one embodiment of the present invention;

FIG. 4 is an exemplary view schematically showing a change rate calculation unit of the device for detecting motions in accordance with one embodiment of the present invention;

FIG. 5 is a view explaining a change rate calculation principle in accordance with one embodiment of the present invention;

FIG. 6 is a view explaining a change rate calculation principle in accordance with another embodiment of the present invention;

FIG. 7 is a view explaining a motion detecting principle in accordance with one embodiment of the present invention;

FIG. 8 is a flowchart schematically showing a method for detecting motions in accordance with one embodiment of the present invention; and

FIG. 9 is a flowchart schematically showing a method for detecting motions in accordance with another embodiment of the present invention.

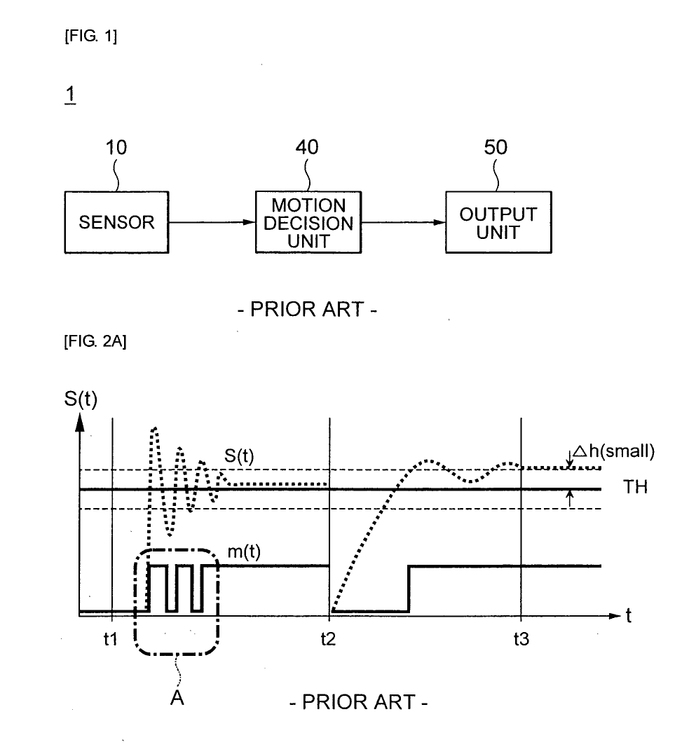

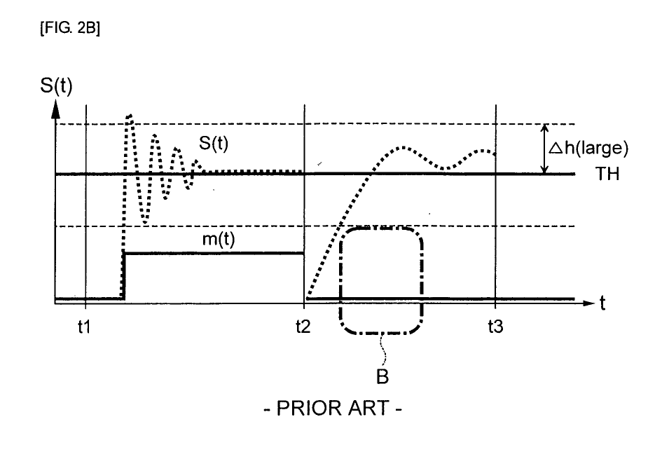

### DETAILED DESCRIPTION OF THE PREFERABLE EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

Terms used herein are provided for explaining embodiments of the present invention, not limiting the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, motions, and/or devices, but do not preclude the presence or addition of one or more other components, motions, and/or devices thereof.

Hereinafter, configurations and operational effects of the present invention will be described in detail with reference to the accompanying drawings.

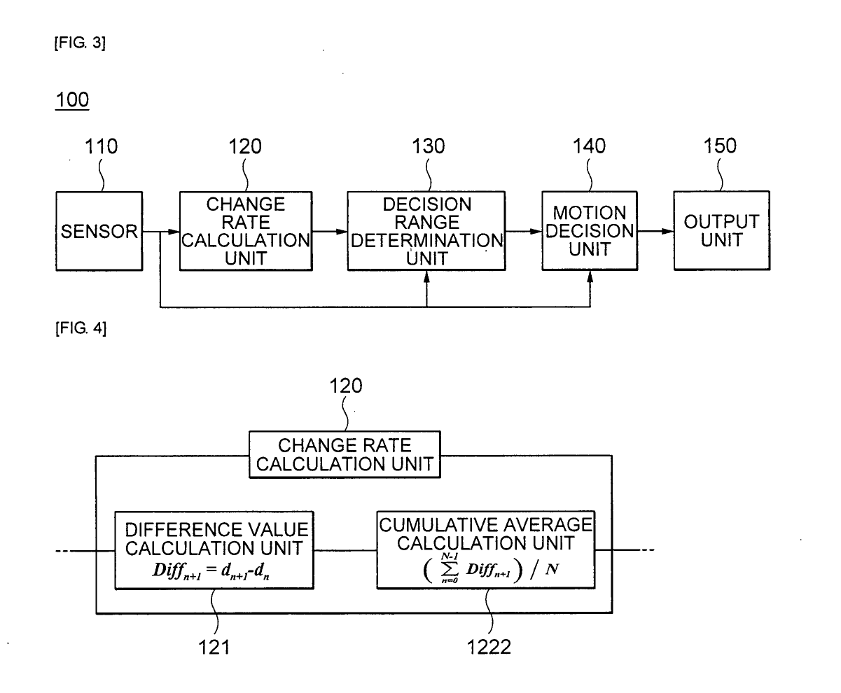

FIG. 3 is an exemplary view schematically showing a device 100 for detecting motions in accordance with one embodiment of the present invention.

Referring to FIG. 3, the device 100 for detecting motions in accordance with one embodiment of the present invention can include a sensor 110, a change rate calculation unit 120, a decision range determination unit 130, a motion decision unit 140 and an output unit 150.

The sensor 110 may be implemented by various inertia sensors 110 widely used already as outputting electric signals changed according to motions by sensing the motions.

The change rate calculation unit 120 plays a role of calculating the change rate of the signals outputted in the sensor 110 by being connected to an output terminal of the sensor 110.

The decision range determination unit 130 is connected to the change rate calculation unit 120 and can play a role of determining an optimum decision range according to the change rate of the signals outputted from the sensor 110.

At this time, the decision range may be defined as a range between an upper value obtained by adding a predetermined tolerance range with reference to a threshold value and a lower value obtained by subtracting the predetermined tolerance range with reference to the threshold value.

According to this, the decision range determination unit 130 can determine the decision range by determining the tolerance range in proportion to the change rate calculated in the change rate calculation unit 120.

In case when the motion rapidly moving during a short time, i.e., having a large acceleration, the change rate of the signals outputted in the sensor 110 becomes larger relatively, in the contrary case, the change rate may be relatively small. The recognition rate may be improved for the motions of various patterns in comparison with the prior art by controlling the decision range so as to be in proportion to such change rate.

The motion decision unit 140 is connected to the sensor 110 and the decision range determination unit 130 and plays a role of determining the existence and inexistence of the motions by reading the signals outputted from the sensor 110 with reference to the decision range determined in the decision range determination unit 130.

The output unit 150 is connected to the motion decision unit 140 and plays a role of outputting the motion detection results as the signals according to the existence and inexistence of the motions determined in the motion decision unit 140. At this time, in case when the motions exist, a signal H is outputted, in the contrary case when the motions do not exist, a signal L can be outputted.

FIG. 4 is an exemplary view schematically showing the change rate calculation unit 120 of the device 100 for detecting motions in accordance with one embodiment of the present invention and FIG. 5 is a view explaining a change rate calculation principle in accordance with one embodiment of the present invention.

Referring to FIG. 4, the change rate calculation unit 120 can include a difference value calculation unit 121 and the change rate calculation unit 120 plays a role of calculating a difference value Diff of signals outputted from the sensor 110.

At this time, the change rate calculation unit 120 can include a representative value selection unit (not shown) to derive as a representative value by selecting a maximum value or an average value among the calculated difference values.

And also, as shown in FIG. 4, a cumulative average calculation unit 122 can be included; and the cumulative average calculation unit 122 can play a role of calculating a cumulative average value by cumulatively summing the difference values calculated in the difference value calculation unit 121.

As shown in FIG. 5, the signals outputted in the sensor 110 form in a shape of a sine wave, divides the time by a predetermined unit, and can calculate the difference between the output values of the sensor 110 in the corresponding time.

In other words, the difference value calculation unit calculates Diffₙ₊₁ as the n+1^{th} difference value according to a following equation 1, wherein the n is zero or a positive integer,

Diffₙ₊₁=dₙ₊₁−dₙ Equation 1.

And also, the cumulative average calculation unit 122 calculates the difference value calculated in the difference value calculation unit 121 according to a following equation 2, wherein the N is zero or a predetermined positive integer,

$$( {\sum }_{n = 0}^{N - 1} {Diff}_{n + 1} ) / N . \qquad Equation 2$$

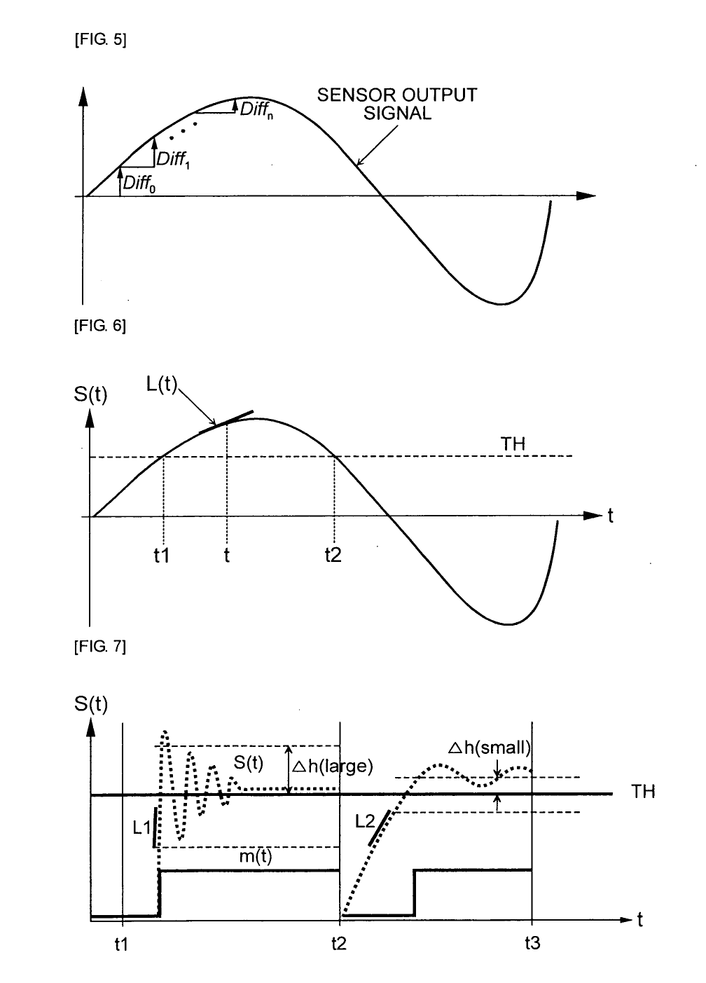

FIG. 6 is a view explaining a change rate calculation principle in accordance with another embodiment of the present invention.

Referring to FIG. 6, the change rate calculation unit 120 can calculate the slopes of signals outputted from the sensor 110; and, particularly, calculates L(t) as a slope at a specific time t according to a following equation 3,

$$L ( t ) = \frac{d}{d t} S ( t ) . \qquad Equation 3$$

On the other hands, as not shown, the change rate calculation unit 120 can include a slope calculation unit to calculate a slope of the signal outputted from the sensor 110 by using the equation 3 and a representative value selection unit to derive a maximum value or an average value of the calculated slope.

FIG. 7 is a view explaining a motion detecting principle in accordance with one embodiment of the present invention. Referring to FIG. 7, the signal outputted by sensing the motions in the sensor 110 may be a signal having a large change rate such as periods t1 to t2 and may be a signal having a small change rate such as periods t2 to t3.

The device 100 for detecting motions in accordance with one embodiment of the present invention can prevent the motion existence signals from being outputted unnecessary by applying the same threshold value TH and the different tolerance range Δh to the output signals from such sensor 110 or can block an erroneous operation to output the motion inexistence signals.

Specifically, the motion sensing recognition rate can be improved by controlling the decision range in a type to increase the tolerance range Δh considering on the pattern characteristics of the signals outputted in the sensor by sensing the motions, if the change rate of the signals are large, and to reduce the tolerance range Δh, if the change rate of the signals is small.

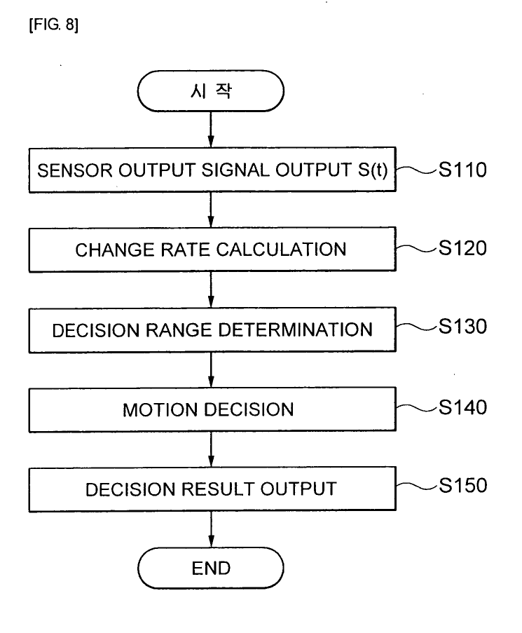

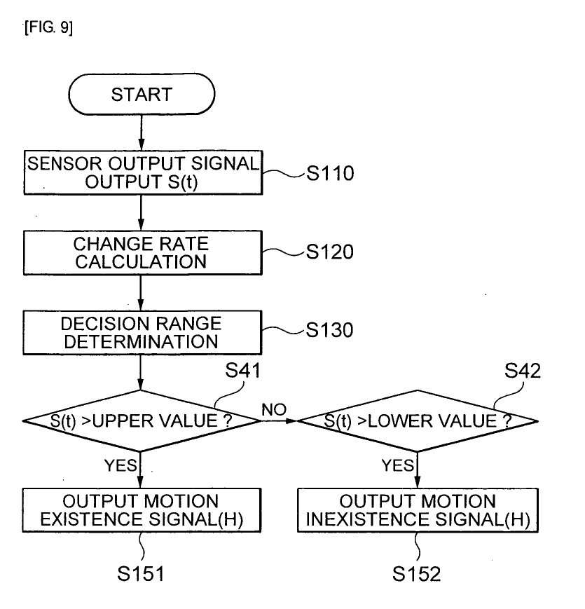

FIG. 8 is a flowchart schematically showing a method for detecting motions in accordance with one embodiment of the present invention. Referring to FIG. 8, the method for detecting motions in accordance with one embodiment of the present invention may be implemented as follows.

At first, if the signals are outputted in the sensor 110 to detect the motions (S110), the change rate of the outputted signal is calculated (S120).

At this time, the change rate calculation may be performed in the methods to calculate a difference value of the output signal and derive a maximum value of an average value or derive a cumulative average value by cumulatively summing.

And also, the change rate calculation may calculate the slope of a tangent line at a specific time for a waveform formed by the output signals of the sensor 110 and perform in a method to derive the maximum value or an average value of the calculated slopes as a representative value.

Thereafter, the decision range is determined considering on the calculated change rate (S130).

At this time, the decision range may be defined as a range between an upper value obtained by adding a predetermined tolerance range with reference to a threshold value and a lower value obtained by subtracting the predetermined range with reference to the threshold value; and, accordingly, the decision range determination unit 130 can determine the decision range by determining the tolerance range in proportion to the change rate calculated in the change rate calculation unit 120.

Thereafter, the existence and inexistence of the motions are decided by reading the signals outputted in the sensor 110 with reference to the determined decision range (S140).

The motion decision unit 140 is connected to the decision range determination unit 130 and plays a role of deciding the existence and inexistence of the motions by reading the signals outputted in sensor 110 with reference to the decision range determined in the decision range determination unit 130.

The output unit 150 is connected to the motion decision unit 140 and plays a role of outputting the motion detection result as a signal according to the existence and inexistence of the motions decided in the motion decision unit 140. At this time, in case when the motions exist, the signal H can be outputted; and, in case when the motions do not exist, the signal L can be outputted.

FIG. 9 is a flowchart schematically showing a method for detecting motions in accordance with another embodiment of the present invention.

Referring to FIG. 9, deciding the motions (S140) decides as the motions exist if the signal outputted in the sensor 110 is larger than the upper value (S141) and outputs the result (S151).

And also, if the signal outputted in the sensor 110 is smaller than the upper value and the signal outputted in the sensor 110 is smaller than the lower value by comparing the signal outputted in the sensor 110 with the lower value (S142), it is decided as the motions do not exist, and the result is outputted (S152).

At this time, the upper value is the value obtained by adding the predetermined tolerance range to the threshold value as an intermediate value of the decision range and it is the maximum value of the decision range determined in determining the decision range (S130).

And also, the lower value is the value obtained by subtracting the predetermined tolerance range from the threshold value as the intermediate value of the decision range and it is the minimum value of the decision ranged determined in determining the decision range (S130).

And also, the tolerance range may be determined in determining the decision range (S130) so as to be a value in proportion to the change range of the output signal in the sensor 110.

Since the present invention constructed by the above can vary the decision range according to the change rate or the slope of the sensor output signals, the recognition rate for the motions of various patterns may be improved as well as the rate of misconception due to the ripple or the sensor output signals or the noise can be reduced.

Embodiments of the invention have been discussed above with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention.

What is claimed is:

1. A device for detecting motions in which existence and inexistence of the motions are determined by comparing signals outputted in a sensor to detect the motions with a predetermined determination range, comprising:
a change rate calculation unit for calculating a change rate of signals outputted from the sensor;
a decision range determination unit for determining the decision range in proportion to the change rate calculated in the change rate calculation unit;
a motion decision unit for deciding the existence and inexistence of the motions from the signals outputted in the sensor based on the decision ranged determined in the decision range determination unit; and
an output unit for outputting the decision result of the motion decision unit.

2. The device for detecting motions according to claim 1, wherein the decision range is ranged between an upper value obtained by adding a tolerance range with reference to a threshold value and a lower value obtained by subtracting the tolerance range with reference to the threshold value.

3. The device for detecting motions according to claim 2, wherein the decision range determination unit determines the decision range by determining the tolerance range in proportion to the change rate calculated in the change rate calculation unit.

4. The device for detecting motions according to claim 1, wherein the change rate calculation unit includes:
a difference value calculation unit for calculating a difference value Diff of signals outputted from the sensor; and
a representative value selection unit for selecting a maximum value or an average value of the difference value calculated in the difference value calculation unit.

5. The device for detecting motions according to claim 1, wherein the change rate calculation unit includes:
a difference value calculation unit for calculating a difference value Diff of signals outputted from the sensor; and
a cumulative average calculation unit for calculating a cumulative average value of the difference value calculated in the difference value calculation unit.

6. The device for detecting motions according to claim 5, wherein the difference value calculation unit calculates Diffₙ₊₁ as the n+1^{th} difference value according to a following equation 1, wherein the n is zero or a positive integer,
Diffₙ₊₁=dₙ₊₁−dₙ Equation 1.

7. The device for detecting motions according to claim 6, wherein the cumulative average calculation unit calculates the difference value calculated in the difference value calculation unit according to a following equation 2, wherein the N is zero or a predetermined positive integer,
$$( {\sum }_{n = 0}^{N - 1} {Diff}_{n + 1} ) / N . \qquad Equation 2$$

8. The device for detecting motions according to claim 1, wherein the change rate calculation unit includes:
a slope calculation unit for calculating slopes of signals outputted from the sensor; and
a representative value derivation unit for deriving a maximum value or an average value of the slopes calculated in the slope calculation unit.

9. The device for detecting motions according to claim 8, wherein the slope calculation unit calculates L(t) as a slope at a specific time 5 according to a following equation 3,
$$L ( t ) = \frac{d}{d t} S ( t ) . \qquad Equation 3$$

10. A method for detecting motions, in which existence and inexistence of the motions are determined by comparing signals outputted in a sensor to detect the motions with a predetermined determination range, comprising:
(A) outputting signals according to motions by detecting the motions;
(B) calculating change rates of the signals outputted in outputting signals;
(C) determining a decision range in proportion to the change rate calculated in the calculating change rates;
(D) determining existence and inexistence of the motions from the signals outputted from the sensor based on the decision range determined in determining the decision range; and
(E) outputting the determined result of the determining existence and inexistence of the motions from the signals.

11. The method for detecting motions according to claim 10, wherein the decision range is ranged between an upper value obtained by adding a tolerance range with reference to a threshold value and a lower value obtained by subtracting the tolerance range with reference to the threshold value.

12. The method for detecting motions according to claim 11, wherein determining the decision range determines the decision range by determining the tolerance range in proportion to the change rate calculated in the calculating change rates of the signals.

13. The method for detecting motions according to claim 10, wherein calculating change rates of the signals includes:
calculating a difference value Diff of signals outputted in the outputting signals according to motions; and
calculating a cumulative average value of the calculated difference values.

14. The method for detecting motions according to claim 13, wherein calculating the difference value Diff of signals calculates Diffn+1 as the n+1th difference value according to a following equation 1, wherein the n is zero or a positive integer,
Diffₙ₊₁=dₙ₊₁−dₙ Equation 1.

15. The method for detecting motions according to claim 14, wherein calculating the cumulative average value of the calculated difference values calculates the difference value calculated in the difference value calculation unit according to a following equation 2, wherein the N is zero or a predetermined positive integer,
$$( {\sum }_{n = 0}^{N - 1} {Diff}_{n + 1} ) / N . \qquad Equation 2$$

16. The method for detecting motions according to claim 10, calculating change rates of the signals includes:
calculating slopes of signals outputted from outputting signals according to motions; and
deriving a maximum value or an average value of the calculated slopes.

17. The method for detecting motions according to claim 16, wherein calculating slopes of signals calculates L(t) as a slope at a specific time 5 according to a following equation 3,
$$L ( t ) = \frac{d}{d t} S ( t ) . \qquad Equation 3$$

18. A method for detecting motions in which existence and inexistence of the motions are determined by comparing signals outputted in a sensor to detect the motions with a predetermined determination range, comprising:
(A) outputting signals according to motions by detecting the motions;
(B) calculating change rates of the signals outputted in outputting signals;
(C) determining a decision range ranging from an upper value obtained by adding a tolerance range with reference to a threshold value to a lower value obtained by subtracting the tolerance range with reference to the threshold value in proportion to the change rate calculated in the calculating change rates;
(D) determining existence and inexistence of the motions from the signals, wherein, if the signal outputted in outputting signals is higher than the upper value determined in determining the decision range, it is determined that the motion exists, whereas, if the signal outputted in outputting signals is lower than the lower value determined in determining the decision range, it is determined that the motion does not exist; and
(E) outputting the determined result of the determining existence and inexistence of the motions from the signals.
